SEQUENCE LISTING (9 sequences)

SEQ ID NO: 1 - DNA, 16 bp, Artificial Sequence
  First sense fragment
gttctgacccacaacg

SEQ ID NO: 2 - DNA, 20 bp, Artificial Sequence
  First antisense fragment
aattcgttgtgggtcagaac

SEQ ID NO: 3 - DNA, 16 bp, Artificial Sequence
  Second sense fragment
caccgcagctttcatg

SEQ ID NO: 4 - DNA, 20 bp, Artificial Sequence
  Second antisense fragment
gatccatgaaagctgcggtg

SEQ ID NO: 5 - DNA, 20 bp, Artificial Sequence
  p53 forward primer
caccatggaggagccacagt

SEQ ID NO: 6 - DNA, 20 bp, Artificial Sequence
  p53 reverse primer
aaggaagtcagtccgagtca

SEQ ID NO: 7 - DNA, 20 bp, Artificial Sequence
  pET200-p53 forward primer
gaattctacgactcactata

SEQ ID NO: 8 - DNA, 20 bp, Artificial Sequence
  pET200-p53 reverse primer
ggatccatttagaaaaataa

SEQ ID NO: 9 - DNA, 1869 bp, Artificial Sequence
  bio-nanowire
aattctacgactcactataggggaattgtgagcggataacaattcccctctagaaataattttgtttaactttaagaaggagatatacatatgcggggttctcatcatcatcatcatcatggtatggctagcatgactggtggacagcaaatgggtcgggatctgtacgacgatgacgataaggatcatcccttcaccatggaggagccacagtcagacctcagcatcgagctccctctgagccaggagacattttcagacctgtggaaactacttcctccaaacaatgttctgtccaccttgccgtcatccgattccattgaagagctgttcctgtcagagaatgttacaggctggttagaagactcaggtggagcgctccaaggggtggcagcagcagcagcttctacagcagaagaccctgtaactgagactcctgcaccggtggcctctgcaccagccactccctggcccctctcatcttctgtcccatcctataaaacctaccagggtgactatggcttccgtctgggcttcctgcactcagggacggccaaatctgtcacgtgcacgtactccccttccctaaataagctattttgccagctggcaaaaacatgccctgtgcagctgtgggtcaactccacccctccacctggcacccgtgtccgtgccatggccatctacaagaagctacaatacatgacagaagttgtaagacgctgccctcaccacgagcgctcctccgaaggcgatagtttggctcctcctcagcatcttatccgagtggaaggaaatttgcatgccgagtacctggatgacaagcaaaaatttcggcacagtgtggtggtaccatatgagccacctgaggttggctctgactgtaccaccatccattacaactacatgtgcaatagttcctgcatggggggcatgaaccggcggcccatccttaccatcatcacactggaagaccccagtggtaacctgctgggacggaacagctttgaggttcgtatttgtgcctgtcctgggagagaccgtcgtaccgaggaaaaaaatttccagaaaaaaggagaaccttgcccagagctgcccccaaagagtgctaaacgagcattgcctaccaacacaagctcctctcccccgccaaagaaaaaaacacttgatggagaatatttcacccttaagatccgaggtcatgagcgcttcaagatgtttcaagagctgaatgaggccttggaattgaaggatgctcaggcttcaaaggggtcagaggacaatggtgctcactccagctacctgaagtccaagaagggccagtctgcctcccgtcttaaaaaactaatgatcaagagagaggggcctgactcggactgacttccttaagggcgagctcaacgatccggctgctaacaaagcccgaaaggaagctgagttggctgctgccaccgctgagcaataactagcataaccccttggggcctctaaacgggtcttgaggagttttttgctgaaaggaggaactatatccggatatcccgcaagaggcccggcagtaccggcataaccaagcctatgcctacagcatccagggtgacggtgccgaggatgacgatgagcgcattgttagatttcatacacggtgcctgactgcgttagcaatttaactgtgataaactaccgcattaaagcttatcgatgataagctgtcaaacatgagaattaattcttgaagacgaaagggcctcgtgatacgcctatttttataggttaatgtcatgataataatggtttcttagacgtcaggtggcacttttcggggaaatgtgcgcggaacccctatttgtttatttttctaaatggatc

(19) United States
(12) Patent Application Publication
(10) Pub. No.: US 2014/0079592 A1
(43) Pub. Date: Mar. 20, 2014

(54) BIO-NANOWIRE DEVICE AND METHOD OF FABRICATING THE SAME

(71) Applicant: National Chiao Tung University, Hsinchu City (TW)

(72) Inventors: Chia-Ching Chang, Hsinchu City (TW); Wen-Bin Jian, Hsinchu City (TW); Yu-Chang Chen, Hsinchu City (TW); Chiun-Jye Yuan, Hsinchu City (TW); Frank Gu, Hsinchu City (TW)

(73) Assignee: National Chiao Tung University, Hsinchu City (TW)

(21) Appl. No.: 14/030,663

(22) Filed: Sep. 18, 2013

(30) Foreign Application Priority Data
Sep. 19, 2012 (TW) 101134278

(51) Int. Cl. G01N 27/02

(52) U.S. Cl. CPC G01N 27/021
USPC 422/69; 435/91.2

(57) ABSTRACT

A bio-nanowire device includes a substrate having a first surface, a first conductor, a second conductor, and a bio-nanowire. The first and second conductors are disposed on the first surface of the substrate, and are spaced apart from each other. The bio-nanowire has two ends respectively connected to the first and second conductors, and includes a nucleic acid molecule having two nucleotide segments, and a plurality of metal ions bonded between the two nucleotide segments of the nucleic acid molecule. The two nucleotide segments form a double helix structure via base pairs. When a voltage or a current is applied to the bio-nanowire, the oxidation state of the metal ions can be changed such that the non-linear electroconductive characteristic of the bio-nanowire can be controlled.

### CROSS-REFERENCE TO RELATED APPLICATION

This application claims priority of Taiwanese Application No. 101134278, filed on Sep. 19, 2012.

### BACKGROUND OF THE INVENTION

1. Field of the Invention

This invention relates to a nanowire device, more particularly to a bio-nanowire device having the characteristics of non-linear conductors.

2. Description of the Related Art

An ordinary material at a nanoscale exhibits different properties compared to the same material at a macroscopic scale. Currently, numerous semiconductor devices employ nanostructures, such as nanodots, nanowires, nanotubes, etc., so as to improve the properties thereof. For example, Taiwan Patent Publication No. 201218421 proposes a light emitting diode (LED) that uses GaN nanowires, each of which includes a P-type GaN segment and an N-type GaN segment that is connected to the P-type GaN segment. A PN junction is formed at the interface between the aforesaid P-type and N-type GaN segments so that each of the GaN nanowires exhibits the characteristics of diodes. However, nanostructured semiconductor devices fabricated using the aforementioned solid inorganic material, e.g., GaN, have fixed properties and limited applications (for instance, the semiconductor device disclosed in the aforesaid Taiwan Patent Publication No. 201218421 can only serve as a LED) such that they are unlikely to be utilized to serve different functions via adjustment of operating conditions thereof.

### SUMMARY OF THE INVENTION

Therefore, the object of the present invention is to provide a nanowire device that can perform different functions the adjustment of operating conditions, and a method of fabricating the same.

According to one aspect of this invention, a bio-nanowire device comprises:
a substrate having a first surface;
a first conductor disposed on the first surface of the substrate;
a second conductor disposed on the first surface of the substrate and spaced apart from the first conductor; and
a bio-nanowire that has two ends respectively connected to the first and second conductors and that includes a nucleic acid molecule having two nucleotide segments, and a plurality of metal ions bonded between the two nucleotide segments of the nucleic acid molecule, said two nucleotide segments form a double helix structure via base pairs,

wherein when a voltage or a current is applied to the bio-nanowire, the oxidation state of the metal ions can be changed such that the non-linear electroconductive characteristic of the bio-nanowire can be controlled.

According to another aspect of this invention, a bio-nanowire device comprises:

a substrate having a first surface;

a first conductor disposed on the first surface of the substrate;

a second conductor disposed apart from the substrate and the first conductor; and

a plurality of electrically isolated bio-nanowires each of which has two ends respectively connected to the first and second conductors and each of which includes a nucleic acid molecule having two nucleotide segments, and a plurality of metal ions bonded to the two nucleotide segments so as to form an electron transport path, said two nucleotide segments form a double helix structure via base pairs,

wherein when a voltage or a current is applied to the bio-nanowires, the oxidation state of the metal ions can be changed such that the non-linear electroconductive characteristic of the bio-nanowires can be controlled.

According to yet another aspect of this invention, a method of fabricating a nanowire device comprises the steps of:
(a) forming separated first and second conductors on a surface of a substrate;
(b) providing first and second linkers each of which is composed of nucleic acids and at least one metal ion that is bonded between the nucleic acids, and connecting the first and second linkers to the first and second conductors, respectively; and
(c) connecting a bio-nanowire to the first and second linkers such that the bio-nanowire interconnects the first and second conductors, the bio-nanowire including a nucleic acid molecule, and a plurality of metal ions bonded to the nucleic acid molecule.

### BRIEF DESCRIPTION OF THE DRAWINGS

Other features and advantages of the present invention will become apparent in the following detailed description of the preferred embodiments of this invention, with reference to the accompanying drawings, in which:

FIG. 1 is a schematic view to illustrate the first preferred embodiment of a bio-nanowire device according to this invention;

FIGS. 2 to 4 are schematic diagrams to respectively illustrate three examples of a bio-nanowire used in the first preferred embodiment;

FIG. 5 is a schematic diagram illustrating how the bio-nanowire is connected to first and second conductors;

FIG. 6 is a flow chart to illustrate a method of fabricating the first preferred embodiment of the bio-nanowire device;

FIG. 7 is a current-voltage graph to illustrate an operating characteristic of the bio-nanowire device of the first preferred embodiment serving as a diode;

FIGS. 8 to 10 are current versus time graphs of the bio-nanowire device of the first preferred embodiment;

FIG. 11 is a current versus time graph to illustrate a characteristic of the bio-nanowire device of the first preferred embodiment serving as a memristor;

FIGS. 12 to 14 are schematic views to illustrate a characteristic of the bio-nanowire device of the first preferred embodiment serving as a spintronic device;

FIG. 15 is a schematic view to illustrate an example of the bio-nanowire device of the first preferred embodiment serving as a biosensor;

FIG. 16 is a schematic view to illustrate the second preferred embodiment of the bio-nanowire device according to this invention;

FIGS. 17 to 22 are schematic diagrams to respectively illustrate six examples of the bio-nanowire used in the second preferred embodiment;

FIG. 23 is a schematic view illustrating how the second preferred embodiment of the bio-nanowire device is fabricated;

FIG. 24 is a flow chart to illustrate a method of fabricating the second preferred embodiment;

FIG. 25 is a schematic view to illustrate the third preferred embodiment of the bio-nanowire device according to this invention;

FIG. 26 is a flow chart to illustrate a method of fabricating the third preferred embodiment; and

FIGS. 27 and 28 are schematic views illustrating how the third preferred embodiment of the bio-nanowire device is fabricated.

### DETAILED DESCRIPTION OF THE PREFERRED EMBODIMENTS

Before the present invention is described in greater detail, it should be noted that the same reference numerals have been used to denote like elements throughout the specification.

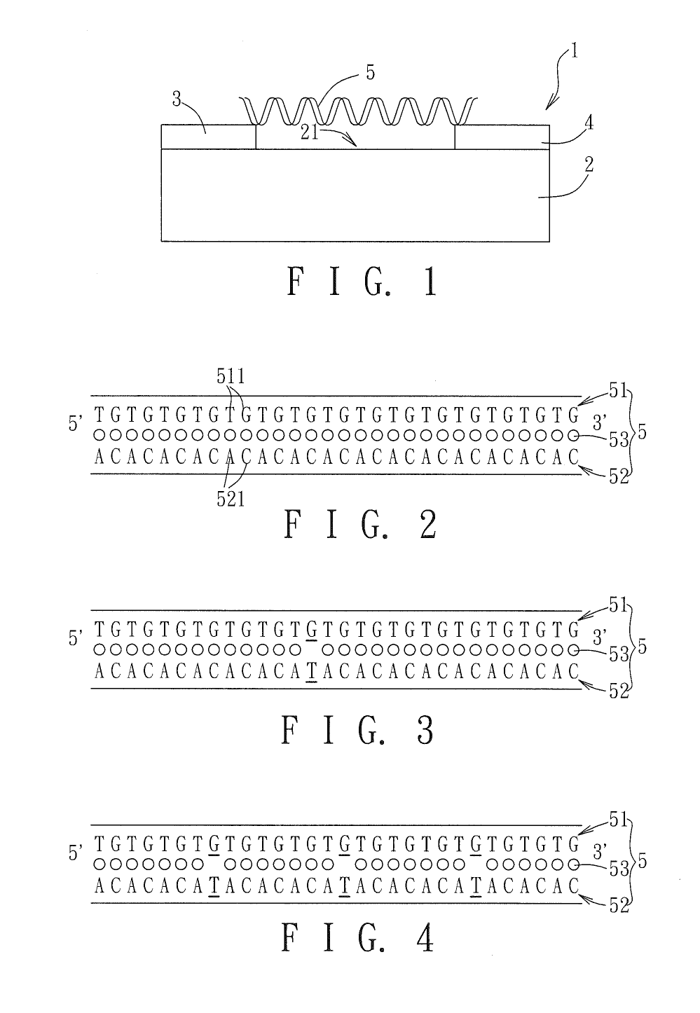

Referring to FIGS. 1 to 4, the first preferred embodiment of a bio-nanowire device 1 according to the present invention is shown. In the first preferred embodiment, by virtue of specific operating conditions (e.g., electric current, voltage, or magnetic field), the bio-nanowire device 1 can be controlled to perform different functions at different operating conditions. For example, under a corresponding operating condition, the bio-nanowire device 1 can perform a respective function so as to serve as a diode, a memristor, a spintronic device, or a bio-sensor.

The bio-nanowire device 1 includes an insulating substrate 2, a first conductor 3, a second conductor 4, and a bio-nanowire 5.

The substrate 2 has a first surface 21. In this embodiment, the substrate 2 is a silicon substrate that has an insulating silicon dioxide layer formed thereon. It should be noted that the substrate 2 is not limited to the aforesaid silicon substrate.

The first conductor 3 and the second conductor 4 are disposed on the first surface 21 of the substrate 2 and are spaced apart from each other. A distance between the first and second conductors 3, 4 ranges from 5 nanometers to 1 micrometer, preferably, from 20 nm to 300 nm. The first and second conductors 3, 4 may be made from metal, graphite, metal oxides, or conductive polymeric materials via common semiconductor technology.

The bio-nanowire 5 is substantially made of a nucleic acid molecule having two nucleotide segments, and a plurality of metal ions 53 that are bonded between the two nucleotide segments of the nucleic acid molecule by virtue of chelation. In this embodiment, the two nucleotide segments of the nucleic acid molecule respectively form first and second nucleotide strands 51, 52 that are helically intertwined via base pairs so as to form a double helix structure. The bio-nanowire 5 has two ends that are respectively connected to the first and second conductors 3, 4 through electrostatic force. A length of the bio-nanowire 5 (i.e. an amount of nucleotides) can be flexibly adjusted based on requirements, as long as the length thereof can be suited for the distance between the first and second conductors 3, 4.

In this embodiment, the interaction of the metal ions with the base pairs of the first and second nucleotide strands 51, 52 is shown in Formula (I). The first and second nucleotide strands 51, 52 form the double helix structure of DNA, and are bonded with each other via hydrogen bonding and chelation of the metal ions 53.

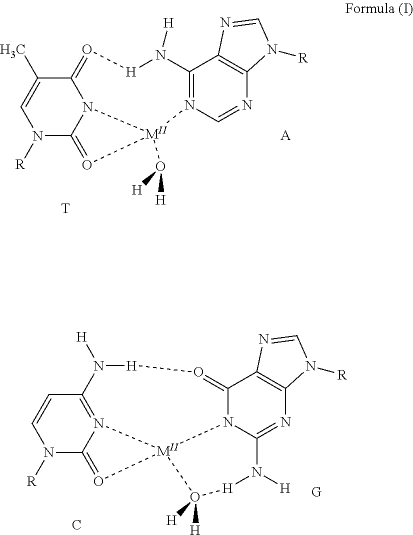

In contrast, ordinary DNA molecules only have first and second nucleotide strands, thereby exhibiting electrically insulating characteristics. The metal ions 53 in the bio-nanowire 5 are arranged to facilitate charge transport through a corridor of the pi-pi interactions of base-pair stacking of the first and second nucleotide strands 51, 52. The bio-nanowire 5 exhibits the electrically conducting characteristics of non-linear conductors.

In detail, the first and second nucleotide strands 51, 52 of the bio-nanowire 5 respectively have a plurality of nucleotides 511, 521. The nucleotides 511, 521 may be deoxyribonucleotides containing bases such as adenine, guanine, thymine, or cytosine, i.e., adenine nucleotides, guanine nucleotides, thymine nucleotides, or cytosine nucleotides. In the figures, A, G, T, and C respectively symbolize the deoxyribonucleotides containing adenine, guanine, thymine, and cytosine bases. It should be noted that the nucleotides 511, 521 may also be ribonucleotides and hence are not limited to the aforesaid deoxyribonucleotides. Furthermore, the metal ions 53 of the bio-nanowire 5 in this embodiment are nickel ions. However, it should be noted that the metal ions 53 may be copper ions, zinc ions, cobalt ions, or iron ions, and hence are not limited to nickel ions.

Referring to FIGS. 2 to 4, the first and second nucleotide strands 51, 52 of the bio-nanowire 5 according to the present invention have arbitrary nucleotide sequences, and are not limited to certain constituents, sequences, amounts, or lengths. Nevertheless, the nucleotides 511, 521 must maintain a certain degree of matching therebetween.

For instance, the nucleotides 511 of the first nucleotide strand 51 are alternate thymine and guanine nucleotides (T and G), the nucleotide 511 at the 5′ end is a thymine nucleotide (T), and the nucleotide 511 at the 3′ end is a guanine nucleotide (G). The nucleotides 521 of the second nucleotide strand 52 are alternate adenine and cytosine nucleotides (A and C), the nucleotide 521 at the 3′ end is an adenine nucleotide (A), and the nucleotide 521 at the 5′ end is a cytosine nucleotide (C). It should be noted that the aforesaid instances are solely intended for the purpose of illustration and should not be construed as limiting the invention in practice.

FIGS. 2, 3, and 4 respectively show that the nucleotides 511, 521 of the first and second nucleotide strands 51, 52 match each other completely, have one mismatch, and have a plurality of mismatches.

Referring to FIG. 2, there is a perfect match between the nucleotides 511 of the first nucleotide strand 51 and the nucleotides 521 of the second nucleotide strand 52 (T-A and G-C). There is always a respective one of the metal ions 53 bonded between the matched nucleotides 511, 521.

Referring to FIG. 3, a cytosine nucleotide (C) in the second nucleotide strand 52 of the bio-nanowire 5 is replaced with a thymine nucleotide (the replaced thymine nucleotide is denoted by T) compared to the bio-nanowire 5 shown in FIG. 2. Consequently, the guanine nucleotide of the first nucleotide strand 51 (denoted by G) at the corresponding position does not match the replaced thymine nucleotide (T) of the second nucleotide strand 52, and no metal ion 53 is bonded therebetween.

Referring to FIG. 4, the nucleotides 511, 521 in the first and second nucleotide strands 51, 52 of the bio-nanowire 5 have three G-T mismatches compared to the bio-nanowire 5 shown in FIG. 2, and no metal ion 53 is bonded between each of the three mismatched pairs.

In view of the foregoing, the nucleotides 511, 521 of the bio-nanowire 5 may have various degrees of matching. The lack of metal ion 53 at a mismatch position gives rise to an energy barrier in the electron transport path, thereby causing hindrance to electron transfer. The larger the amount of the mismatches of the nucleotides 511, 521 in the bio-nanowire 5, the higher the resistance of the bio-nanowire 5 will be. Nonetheless, to perform electrically conducting characteristics of the bio-nanowire 5, the nucleotides 511, 521 thereof preferably have at least 70% complementary base pairing, more preferably, at least 80% complementary base pairing, and most preferably, 100% complementary base pairing such that the object of the present invention can be achieved.

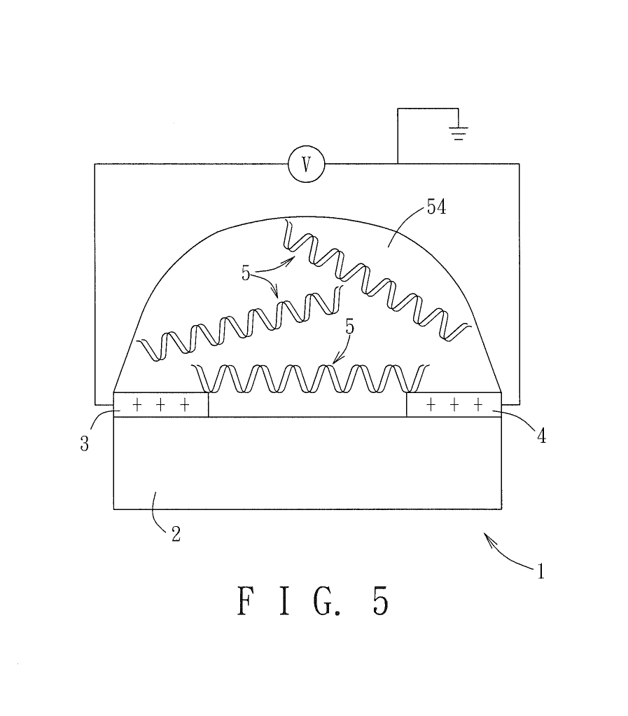

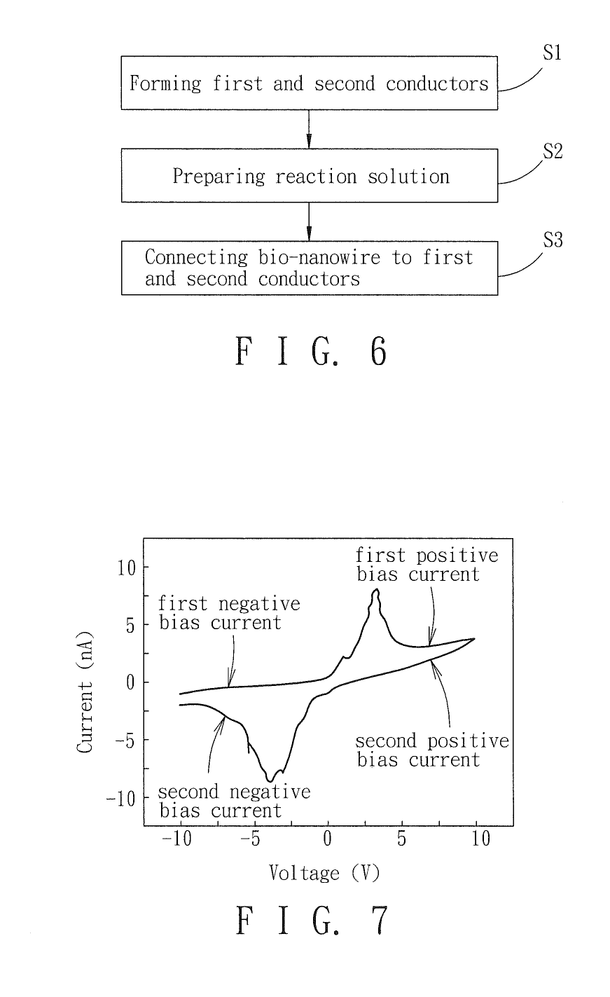

Referring to FIGS. 5 and 6, a method of fabricating the first preferred embodiment of the bio-nanowire device 1 of this invention will now be described.

### Step S1: Formation of First and Second Conductors 3, 4

In this embodiment, the first and second conductors 3, 4 are formed using a lift-off process. It should be noted that the first and second conductors 3, 4 may also be formed by virtue of an etching process, and the method of forming the first and second conductors 3, 4 is not limited to the aforesaid processes.

In detail, a photoresist pattern for the first and second conductors 3, 4 is defined on the first surface 21 of the substrate 2 through a photolithography or electron-beam lithography or other lithography process. A titanium coating of 5 nm and a gold coating of 50 nm are sequentially formed on the photoresist layer and the portion of the first surface 21 of the substrate 2, which is not covered by the photoresist layer, via E-gun evaporation, thermal evaporation, or other thin-film coating techniques. Subsequently, the photoresist layer and the portions of the titanium and gold coatings on the photoresist layer are removed such that the first and second conductors 3, 4 are formed. It should be noted that the materials used to form the first and second conductors 3, 4 are not limited to the aforesaid materials.

### Step S2: Preparation of Reaction Solution 54

A preparation method of reaction solution 54 containing the bio-nanowires 5 is as follows.

DNA molecules (each including first and second nucleotide strands 51, 52, as shown in FIG. 2, FIG. 3, or FIG. 4 but containing no chelated metal ions 53) are added into a 10 mM Tris-HCl buffer solution (pH 9.0). The concentration of the resultant solution is adjusted to 12.5 ng/μL while the pH is maintained at 9.0. Namely, 1 L of the DNA solution thus formed contains 12.5 mg of the aforesaid DNA molecules.

A 10 mM Tris-HCl buffer solution and a 2.5 mM NiCl₂ solution are added into the DNA solution while the pH is maintained at 9.0. The reaction is allowed to proceed for at least 8 hours so that the aforesaid DNA molecules and nickel ions undergo chelation. Therefore, reaction solution 54 containing the bio-nanowires 5 as shown in FIG. 2, FIG. 3, or FIG. 4 is prepared.

### Step S3: Connection of Bio-Nanowire 5 to First and Second Conductors 3, 4

The bio-nanowire 5 includes a plurality of the positively charged metal ions 53 (which are nickel ions in this embodiment). Since the first and nucleotide strands 51, 52 include phosphate groups which are negatively charged, the bio-nanowire 5 overall is negatively charged. This step employs an electrophoresis technique. In general, a positive voltage is applied to the first and second conductors 3, 4. Consequently, by virtue of electrostatic force, the bio-nanowire 5 is adsorbed to the first and second conductors 3, 4, more precisely, is stretched so that the two ends thereof are respectively connected to the first and second conductors 3, 4.

Referring to FIG. 5, the method of connecting the bio-nanowire 5 to the first and second conductors 3, 4 will now be described. Reaction solution 54 containing the bio-nanowires 5 is dialyzed against double-distilled water at 4° C. for 8 hours so as to remove excess salts and the nickel ions 53. Thereafter, about 5 μL of the reaction solution 54 is added dropwise onto and between the first and second conductors 3, 4.

A positive voltage of +1 V is applied to the first and second conductors 3, 4 for 20 minutes so that the bio-nanowires 5 in the reaction solution 54 are adsorbed and hence connected to the first and second conductors 3, 4 via electrophoresis. During this procedure, the reaction solution 54 may be hermetically sealed with a cover so as to maintain the concentration thereof.

The excess reaction solution 54 remaining on the first and second conductors 3, 4 is slowly blown off using nitrogen gas, thereby completing the fabrication of the bio-nanowire device 1.

It should be noted that the materials and thicknesses of the first and second conductors 3, 4, the solution concentration, the pH value, the voltage, the time required for connecting the bio-nanowire 5 to the first and second conductors 3, 4, etc. described above are solely provided for the purpose of illustration. Furthermore, the amount of the bio-nanowire 5 connected to the first and second conductors 3, 4 may also be more than one, and can be adjusted as needed.

The bio-nanowire 5 in this embodiment is composed of a double-stranded structure consisting of the first and second nucleotide strands 51, 52. However, the bio-nanowire 5 may also be composed of a single-stranded structure.

In detail, when the bio-nanowire 5 is composed of a single-stranded structure, the single-stranded structure includes the two nucleotide segments. One of the segments is similar to the first nucleotide strand 51 as shown in FIGS. 2 to 4, and has a nucleotide sequence consisting of thymine (T) and guanine (G). The other of the segments is similar to the second nucleotide strand 52 as shown in FIGS. 2 to 4, and has a nucleotide sequence consisting of adenine (A) and cytosine (C). The two nucleotide segments may be directly connected to each other.

The aforesaid single-stranded structure is bent at a middle position between the two nucleotide segments, and a double helix structure is thus formed by the two nucleotide segments via hydrogen bonding. Metal ions 53 are bonded between the two nucleotide segments via chelation. The bio-nanowire 5 composed of the aforesaid single-stranded structure hence is quite similar to the bio-nanowire 5 composed of the double-stranded structure as shown in FIGS. 2 to 4, thereby also being able to perform the same function. Accordingly, it should be noted that the structure of the bio-nanowire 5 can be flexibly adjusted depending on requirements, and is not limited to the aforesaid structure.

In this invention, when a voltage or a current is applied to the bio-nanowire 5, the oxidation state of the metal ions 53 can be changed such that the non-linear electroconductive characteristic of the bio-nanowire 5 can be controlled.

### Use of Bio-Nanowire Device 1 as Diode

Use of the bio-nanowire device 1 as a diode is illustrated with reference to FIGS. 7 to 10.

FIG. 7 shows a current-voltage (I-V) curve obtained by applying a DC voltage to the first and second conductors 3, 4 of the bio-nanowire device 1. The DC voltage is gradually increased from −10 V to +10 V, and is then gradually reduced from +10 V to −10 V. The current values corresponding to the different voltage values are shown in FIG. 7.

First, a voltage of −10 V is applied to the bio-nanowire device 1 so that all of the metal ions 53 in the bio-nanowire 5 are induced to have a relatively lower oxidation state, i.e., all of the nickel ions are induced to have an oxidation state of +2 (Ni²⁺). When the voltage is gradually increased from −10 V to 0 V, the bio-nanowire device 1 carries a first negative bias current with a very small magnitude (very close to 0 nA). Subsequently, when the voltage is gradually increased from 0 V to +10 V, the bio-nanowire device 1 exhibits a first positive bias current that is greater in magnitude than the first negative bias current. The first positive bias current is rapidly increased in magnitude when the voltage is increased from 0 V to +3 V, and reaches a peak value (about 7.5 nA) at +3 V. The first positive bias current is reduced to about 2.6 nA when the voltage is increased from +3 V to +5 V, and is slowly increased in magnitude when the voltage is increased from +5 V to +10 V.

In other words, the metal ions 53 in the bio-nanowire 5 can be induced to have a relatively lower oxidation state by virtue of a negative setting voltage (which is −10 V in this example but is not limited thereto). In this relatively lower oxidation state, the first positive bias current of the bio-nanowire device 1 is greater in magnitude than the first negative bias current thereof such that the bio-nanowire device 1 exhibits electrically conducting characteristics similar to those of ordinary diodes. Since the bio-nanowire device 1 exhibits a current-voltage characteristic that is non-linear and that is not always gradually increased in magnitude when the applied voltage is positive, the electrically conducting characteristics thereof are not identical to those of ordinary diodes.

In addition, the metal ions 53 in the bio-nanowire 5 can be induced to have a relatively higher oxidation state (Ni³⁺ in this example) by virtue of a positive setting voltage (which is +10 V in this example). In this relatively higher oxidation state, the bio-nanowire device 1 exhibits a second positive bias current with a small magnitude when the voltage is gradually reduced from +10 V to 0 V. When the voltage is gradually reduced from 0 V to −10 V, the bio-nanowire device 1 exhibits a second negative bias current that is generally greater in magnitude than the second positive bias current thereof. Furthermore, since the second negative bias current exhibits a current-voltage characteristic that is non-linear and that is not always gradually increased in magnitude, the same is similar to the first positive bias current.

Therefore, in the relatively higher oxidation state, the bio-nanowire device 1 exhibits an electrically conducting property that is opposite to that of the bio-nanowire device 1 in the relatively lower oxidation state, and has a current-voltage characteristic that is generally opposite to that of ordinary diodes. Accordingly, by virtue of a positive setting voltage or a negative setting voltage, the bio-nanowire device 1 can be induced to have a relatively higher oxidation state or a relatively lower oxidation state such that the bio-nanowire device 1 can have opposite electrically conducting properties to perform different functions.

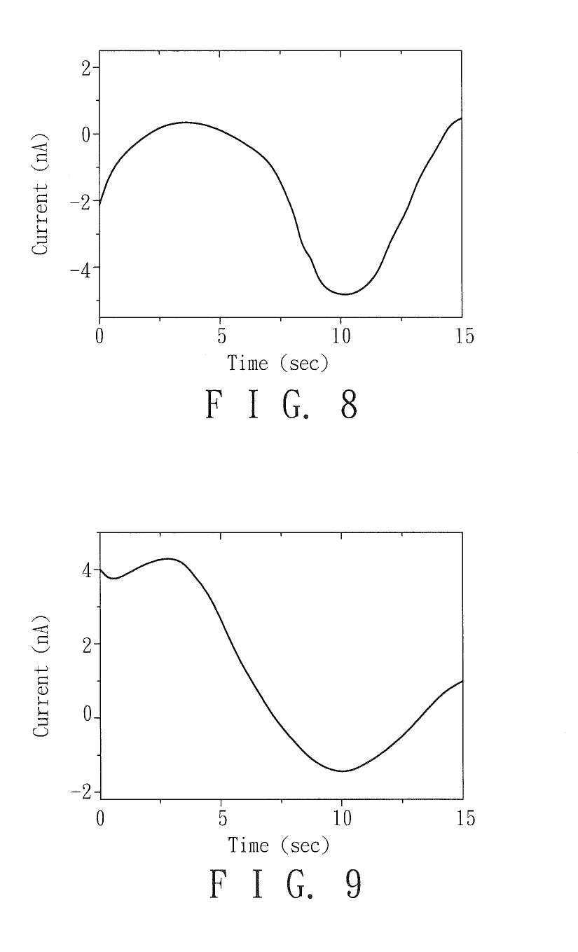

FIG. 8 shows the current values at different time points as obtained by first applying a positive setting voltage of +6 V to the bio-nanowire device 1 so as to induce the same to have a relatively higher oxidation state, and then by inputting a sine wave voltage having positive and negative peaks of ±1.5 V. When the sine wave voltage ranges from 0 V to +1.5 V (i.e., positive voltage), the peak positive current is 0˜1 nA. When the sine wave voltage ranges from −1.5 V to 0 V (i.e., negative voltage), the peak negative current is close to −5 nA. Under the aforesaid operating conditions, the bio-nanowire device 1 has a greater current in magnitude at a negative voltage compared to a current thereof at a positive voltage, thereby exhibiting an electrically conducting property opposite to that of ordinary diodes.

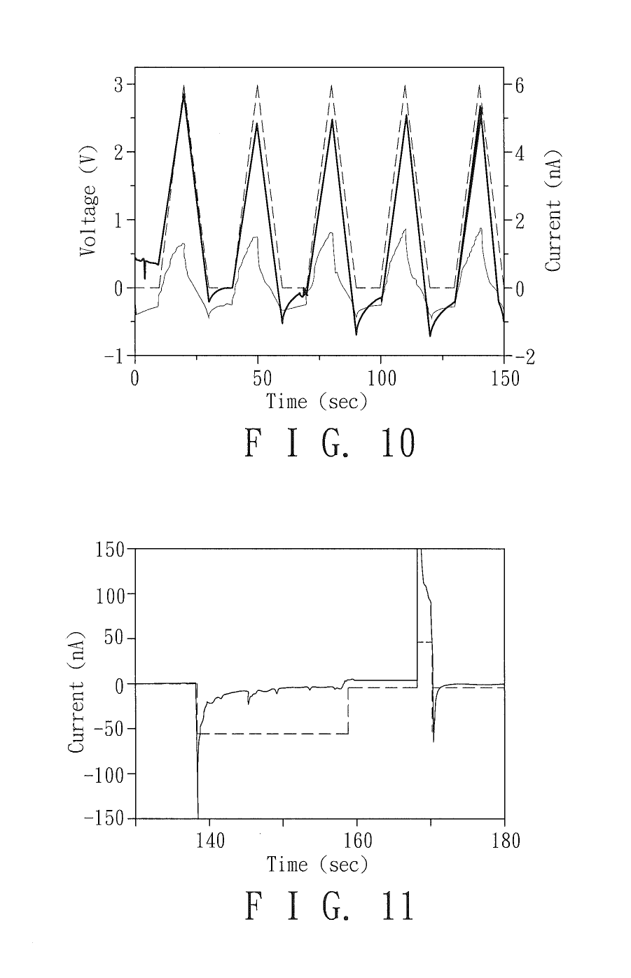

FIG. 9 shows the current values at different time points as obtained by first applying a negative setting voltage of −6 V to the bio-nanowire device 1 so as to induce the same to have a relatively lower oxidation state, and then by inputting a sine wave voltage having positive and negative peaks of ±1.5 V. When the sine wave voltage ranges from 0 V to +1.5 V (i.e., positive voltage), the peak positive current is slightly larger than 4 nA. When the sine wave voltage ranges from −1.5 V to 0 V (i.e., negative voltage), the peak negative current is −1˜−2 nA. Thus, the bio-nanowire device 1 has a greater current in magnitude at a positive voltage compared to a current thereof at a negative voltage, thereby exhibiting an electrically conducting property similar to that of ordinary diodes.

As shown in FIGS. 8 and 9, since the bio-nanowire 5 can be induced to have a relatively higher oxidation state or a relatively lower oxidation state, the bio-nanowire device 1 can exhibit opposite electrically conducting properties even when the same sine wave voltage is applied thereto. Therefore, via application of a positive setting voltage or a negative setting voltage, the bio-nanowire device 1 can be used to perform a desired function for serving as a desired element.

Referring to FIG. 10, similarly, when a triangular wave voltage is applied to the bio-nanowire device 1 in a relatively higher oxidation state or a relatively lower oxidation state, the bio-nanowire device 1 also has a respective current. As shown in FIG. 10, the dashed line represents the inputted triangular wave voltage (ranging from 0 V to +3 V), the bold line represents the current of the bio-nanowire device 1 in a relatively lower oxidation state (the peaks thereof range from 5 nA to 6 nA), and the fine line represents the current of the bio-nanowire device 1 in a relatively higher oxidation state (the peaks thereof range from 1 nA to 2 nA). Since the bio-nanowire device 1 can be induced to have a relatively higher oxidation state or a relatively lower oxidation state, the bio-nanowire device 1 can have different currents even when the same triangular wave voltage is applied. The aforesaid characteristic is also a diode characteristic of the bio-nanowire device 1.

It should be noted that input voltages used for illustrating the operating characteristics of the bio-nanowire device 1 serving as a diode are not limited to the DC voltage, sine wave voltage, and triangular wave voltage as disclosed above, and may also be other types of input voltages (e.g., square wave voltage).

### Use of Bio-Nanowire Device 1 as Memristor

Use of the bio-nanowire device 1 as a memristor is illustrated with reference to FIG. 11.

A random access memory (RAM) is an electronic component commonly used in various electronic devices, and is able to store data via a plurality of capacitors therein. The capacitor which is saturated with electrical energy exhibits a binary state of “1”, and the capacitor which does not store electrical energy exhibits a binary state of “0”. When an electronic device is shut down or suffers from loss of power, a RAM may lose the data stored therein, thereby being in need of improvement.

A memristor may be used to replace the conventional RAM. A memristor is a memory component that is capable of maintaining the resistance thereof so as to preserve the data stored therein even after an electronic device is shut down or suffers from loss of power. To be specific, a memristor is characterized by the following formula:

V(t)=M(q(t))×I(t) (I)

where V(t) is the voltage as a function of time, q(t) is the electric charge as a function of time, I(t) is the current as a function of time, and M(q(t)) is the resistance of the memristor (i.e., memristance) as a function of the electric charge.

As evident from the above-mentioned formula, the resistance of a memristor is controlled by the amount of the electric charge at a certain time point. When a voltage or a current is applied to a memristor, the resistance thereof is changed. After the voltage or the current is removed, the resistance of the memristor can be hence maintained at the level before removal of the voltage or the current. Consequently, a memristor exhibits characteristics of resistive memories.

When a respective one of voltages corresponding to the binary data “1” and “0” (e.g. +5 V and +1 V) is applied to a memristor, the resultant resistance of the memristor, which corresponds to the respective binary datum, is used as an index. Thus, once the resistance of the memristor is determined, the datum stored in the memristor, i.e., “1” or “0”, can be inferred immediately. Since the resistance of a memristor remains unchanged after removal of power, the data stored in the memristor can be prevented from being lost.

In this embodiment, when a positive setting voltage or a negative setting voltage is applied to the bio-nanowire device 1, the metal ions 53 are induced to have a relatively higher oxidation state or a relatively lower oxidation state. The resultant relatively higher oxidation state and the resultant relatively lower oxidation state can only be changed respectively by subsequent application of a new negative setting voltage or a new positive setting voltage. In other words, removal of power is unable to change an oxidation state of the metal ions 53. Accordingly, the bio-nanowire device 1 of this invention is able to maintain the same resistance after removal of power, thereby having operating characteristics of memristors.

Furthermore, the relatively higher and lower oxidation states may be designated to data “+1” and “−1”. The initiation state at which no external bias voltage is provided may be designated to datum “0”. The stored data can be inferred by determining a current-voltage characteristic of the bio-nanowire device 1 so as to deduce whether the bio-nanowire device 1 has a relatively higher oxidation state or a relatively lower oxidation state.

FIG. 11 shows the current values for accessing the datum stored in the bio-nanowire device 1 (represented by the solid line) as obtained by first applying a negative setting voltage of −6 V to the bio-nanowire device 1 so as to induce the same to have a relatively lower oxidation state (corresponding to the datum “−1”), and then by applying a respective one of square wave voltages having a peak negative voltage of −1 V and a peak positive voltage of +1 V (represented by the dashed line) to the bio-nanowire device 1. When the square wave voltage having the peak negative voltage of −1 V is applied, the current thus measured (approximately ranging from 0 nA to −25 nA) is relatively small in magnitude. When the square wave voltage having the peak positive voltage of +1 V is applied, the current thus measured (generally ranging from 80 nA to 150 nA) is relatively large. Based on the result of the previous example, the aforesaid current-voltage relationship indicates that the bio-nanowire device 1 has a relatively lower oxidation state, thereby confirming that the datum stored in the bio-nanowire device 1 is “−1”. Similarly, via a positive setting voltage of +6 V, the bio-nanowire device 1 can be induced to have a relatively higher oxidation state which corresponds to the datum “1”, and the datum stored in the bio-nanowire device 1 can be inferred by virtue of a current-voltage relationship.

It should be noted that the aforesaid setting voltages of +6 V and −6 V for inducing the bio-nanowire device 1 to have a specific oxidation state, and the aforesaid square wave voltages having the peak positive and negative voltages of +1 V and −1 V for determining a current-voltage relationship are solely intended for the purpose of illustration. Any setting voltage capable of inducing the bio-nanowire device 1 to have a relatively higher oxidation state or a relative lower oxidation state, and any applied voltage suitable for determining a current-voltage relationship of the bio-nanowire device 1 may be utilized.

Data storage can be achieved not only through the binary numeral system, but also through the following system. As shown in the formula (I) mentioned above, the resistance of the bio-nanowire device 1, M(q(t)), is a function of time. Namely, when the input voltage V varies with time, the corresponding resistance and the corresponding electric charge regarding the bio-nanowire device 1 also change with time. The resultant changes can be found by a detection device. The change of the electric charge with time ranges from 0 to 2N. N represents the amount of base pairs in a nucleic acid molecule. Thus, the bio-nanowire device 1 is able to store data not only via the binary numeral system, but also via an 2N-nary numeral system (i.e., a multinary numeral system) based on the amount of the base pairs in the bio-nanowire 5. In this embodiment, N may range from 60 to 2000, but is not limited to the aforesaid range.

### Use of Bio-Nanowire Device 1 as Spintronic Device

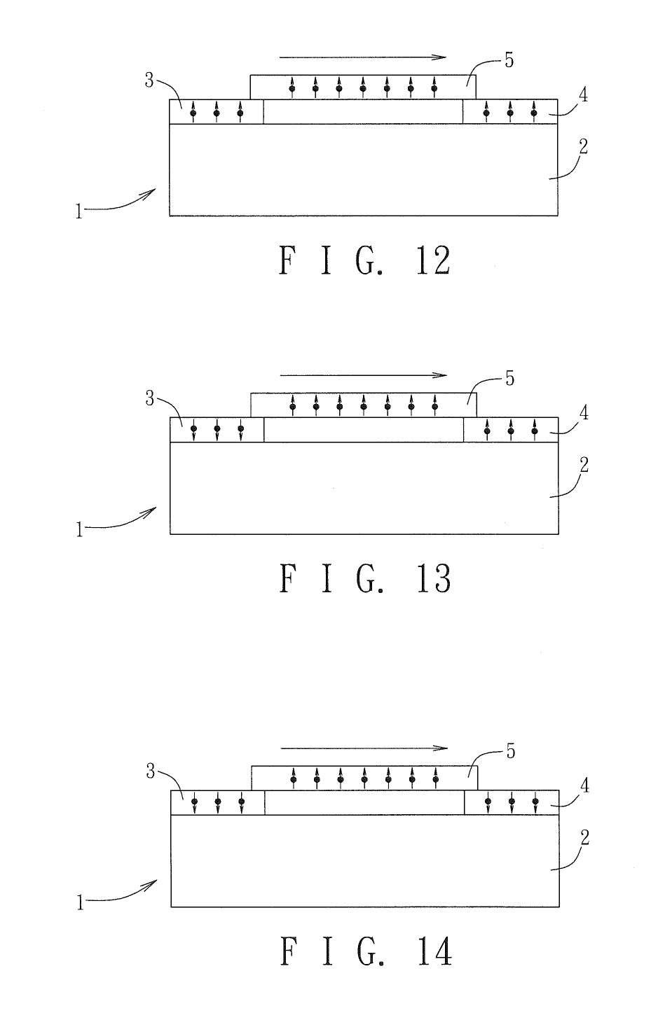

Use of the bio-nanowire device 1 as a spintronic device is illustrated with reference to FIGS. 12 to 14.

An electron is a subatomic particle with a negative charge, and the spin thereof is “+½” or “−½”. A spintronic device is a device that is able to determine electron spin by detecting the change in resistance.

In general, a spintronic device normally includes an electron transport channel and two electrodes that are respectively connected to two ends of the electron transport channel. After a magnetic field is applied to the electrodes, electrons in the electrodes can be induced to have the same spin, i.e. +½ or −½. Once the electrons of the two electrodes have the same spin, a voltage can be applied to the electrodes so that the electrons in one of the electrodes are transported to the other one of the electrodes through the electron transport channel. Since the electrons of the electrodes have the same spin, the electrons do not undergo spin-flip scattering when being transported such that resistance is smaller. On the other hand, when the electrons of the two electrodes have the opposite spins, the electrons undergo spin-flip scattering when being transported such that resistance is larger. Accordingly, by measuring the resistance of a spintronic device, the spin of electrons in the spintronic device can be determined. In addition, the change in resistance can be detected by determining the value or the phase regarding a current and a voltage.

In this embodiment, when the bio-nanowire device 1 is used as a spintronic device, the bio-nanowire 5 serves as an electron transport channel, and the first and second conductors 3, 4 are required to be made of a magnetic metal (such as iron, cobalt, and nickel) so as to induce the electron spin via a magnetic field.

Referring to FIGS. 12 to 14, a voltage is applied to the bio-nanowire device 1, and the first and second conductors 3, 4 are respectively induced to have lower and higher electric potentials so that electrons in the first conductor 3 are transported to the second conductor 4 through the bio-nanowire 5. In FIGS. 12 to 14, black circles represent electrons, arrows pointing up (↑) represent the electron spin of +½, arrows pointing down (↓) represent the electron spin of −½, and horizontal arrows (→) represent the direction of electron transport.

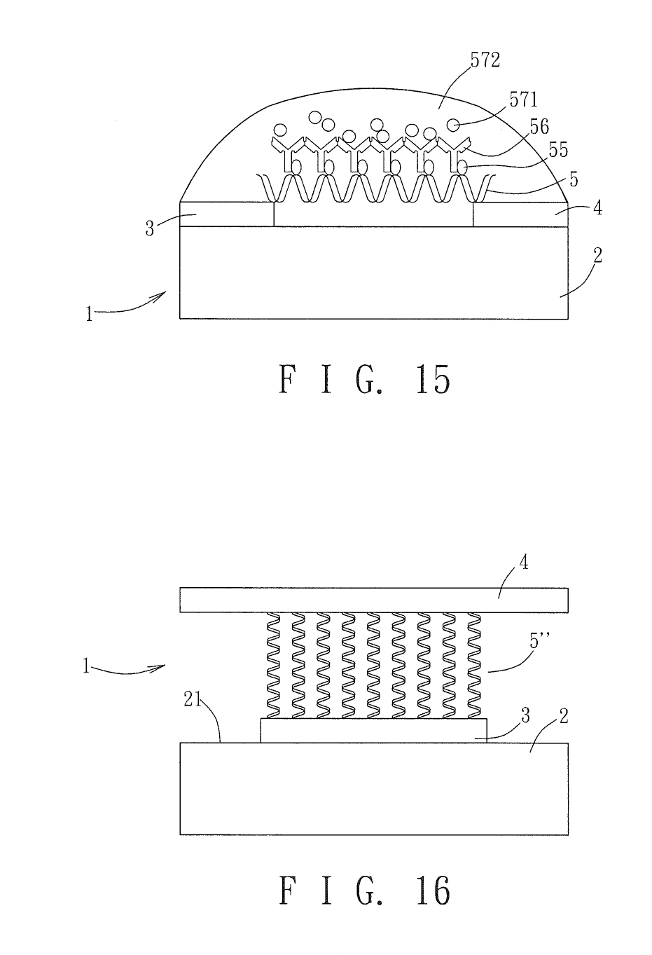

Referring to FIG. 12, after the first conductor 3, the bio-nanowire 5, and the second conductor 4 are subjected to a magnetization process, the electrons in the aforesaid three components have the same spin, i.e., +½, such that the resistance measured after a voltage is applied (referred to as R1) is the lowest. Referring to FIG. 13, the electrons in the first conductor 3 have the spin different from that of the electrons in the bio-nanowire 5 and the second conductor 4, such that the resistance thus measured (referred to as R2) is higher than R1. Further referring to FIG. 14, the electrons in the bio-nanowire 5 have the spin different from that of the electrons in the first and second conductors 3, 4, such that the resistance thus measured (referred to as R3) is the highest. Consequently, the aforesaid three resistances can be ranked in decreasing order as follows: R3>R2>R1. Accordingly, by measuring the resistance of the bio-nanowire device 1, the spin of electrons can be determined, and the relative magnetization state among the first conductor 3, the second conductor 4, and the bio-nanowire 5 can also be further determined.

Furthermore, in this embodiment, the bio-nanowire 5 can be magnetized by virtue of a voltage. For instance, when the metal ions 53 of the bio-nanowire 5 are non-magnetized, and when the electrons in the first and second conductors 3,4 have the same spin, a voltage can be applied to transport the electrons in the first conductor 3 to the second conductor 4 through the bio-nanowire 5 so that the electrons in the metal ions 53 of the bio-nanowire 5 are induced to have same spin as that of the electrons in the first and second conductors 3, 4 (i.e., the electrons in the metal ions 53 of the bio-nanowire 5 exhibit the magnetization state similar to that shown in FIG. 12).

### Use of Bio-Nanowire Device 1 as Biosensor

Use of the bio-nanowire device 1 as a biosensor is illustrated with reference to FIG. 15.

As shown in FIG. 15, in an example of this embodiment, the phosphate groups (not shown) in the first and second nucleotide strands 51, 52 of the bio-nanowire 5 are respectively bonded to protein G B1 domains (PGB1s) 55 by virtue of 1-ethyl-3-[3-dimethylaminopropyl]carbodiimide hydrochloride (EDC), and each of the PGB1s 55 is also bonded to an immunoglobulin G (IgG) 56. Therefore, a bioanalyte 571 capable of binding to the matching IgG 56 could be detected.

In operation, a sample solution 572 can be added dropwise to the bio-nanowire 5, or the bio-nanowire device 1 can be soaked in the sample solution 572, so that examination of the bioanalytes 571 in the sample solution 572 could be conducted. It should be noted that the bio-nanowire device 1 may further include a fluidic channel (not shown) allowing the sample solution 572 to flow therethrough to the bio-nanowire 5 for examination. In detail, the examination of the bioanalytes 571 is conducted by first applying a voltage or an electric power to the bio-nanowire device 1, and by subsequently determining the change in the current or the voltage regarding the bio-nanowire device 1. The bioanalytes 571 in the sample solution 572 capable of binding to the IgGs 56 could be detected via the resultant change in the current or the voltage regarding the bio-nanowire device 1. It should also be noted that the aforesaid PGB1s 55 and IgGs 56 are solely intended for the purpose of illustration, and other suitable binding proteins and immunoglobulins can be used to examine a bioanalyte.

### Use of Bio-Nanowire Device 1 as Anisotropic Conductive Structure

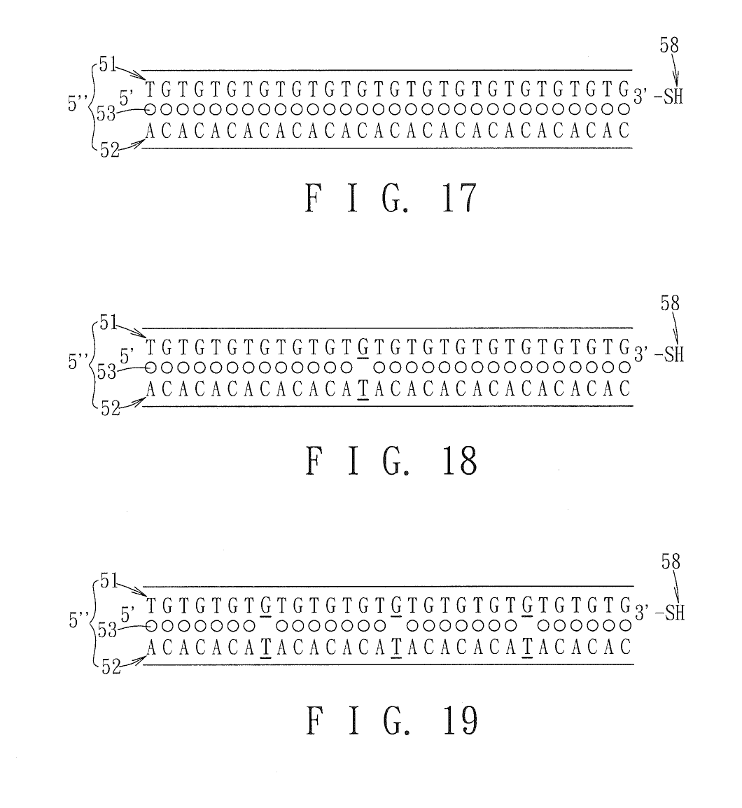

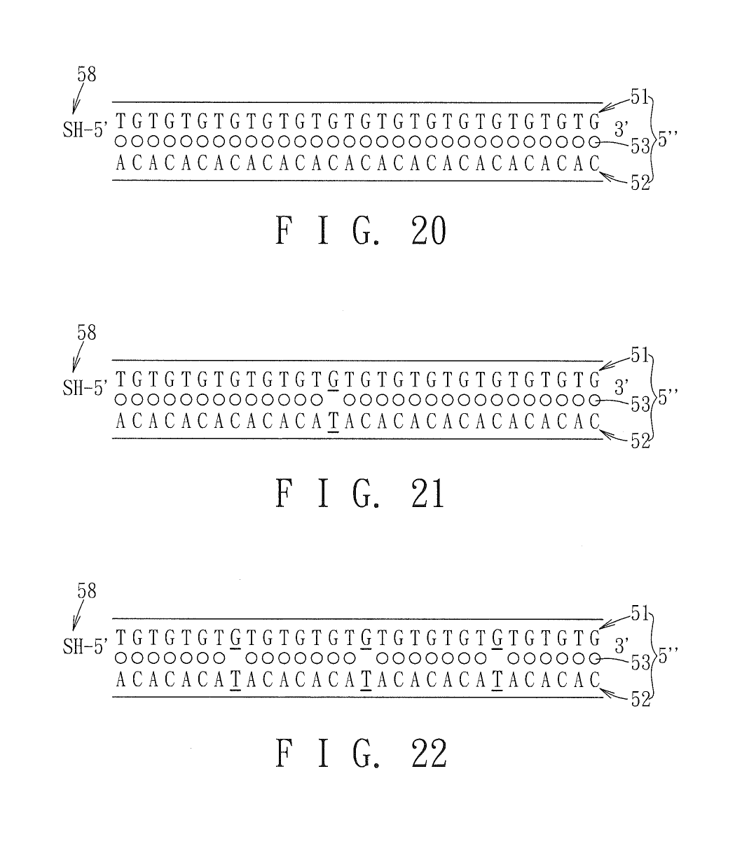

The second preferred embodiment of the bio-nanowire device 1 according to the present invention and use of the same as an anisotropic conductive structure are illustrated with reference to FIGS. 16 to 22.

As shown in FIG. 16, the bio-nanowire device 1 includes a substrate 2, a first conductor 3, a second conductor 4, and a plurality of bio-nanowires 5″. The substrate 2 has a first surface 21. The first conductor 3 is disposed on the first surface 21 of the substrate 2, and is made of gold, silver or copper. The second conductor 4 is disposed apart from the substrate 2 and the first conductor 3. One end of each of the bio-nanowires 5″ is vertically connected to the first conductor 3 via a self-assembly monolayer (SAM) technique (the process of connecting the bio-nanowires 5″ to the first conductor 3 will be described in detail in the following paragraphs). The other end of each of the bio-nanowires 5″ is connected to the second conductor 4. Thus, the second conductor 4 is electrically connected to the first conductor 3 by virtue of the bio-nanowires 5″.

As shown in FIGS. 17 to 22, the structure of the bio-nanowire 5″ according to the second preferred embodiment and that of the bio-nanowire 5 according to the first preferred embodiment (see FIGS. 2 to 4) are similar, e.g., the first and second nucleotide strands 51, 52 of each of the bio-nanowire 5″ match each other completely in nucleotide sequence, have one mismatch, or have a plurality of mismatches in nucleotide sequence. The nucleotide segments may respectively form first and second nucleotide strands 51, 52 or may be included in a single-stranded structure. The difference between the first and second preferred embodiment resides in that at least one of the first and second nucleotide strands 51, 52 of the bio-nanowire 5″ according to the second preferred embodiment further has a thiol group 58 (—SH group) bonded to the 3′ end or the 5′ end thereof. Since the thiol group 58 of the bio-nanowire 5″ and the first conductor 3 can form a gold-sulfur bond, a silver-sulfur bond or a copper-sulfur bond, the bio-nanowire 5″ is capable of being connected to the first conductor 3.

Furthermore, since the first and second nucleotide strands 51, 52 of the bio-nanowire 5″ exhibit insulating properties, and since the metal ions 53 bonded between the first and second nucleotide strands 51, 52 together serve as an electron transport path, the bio-nanowire 5″ can be considered as a micro-cable that is enclosed by an insulating layer. The plurality of the bio-nanowires 5′ cooperate to form a structure similar to that of coaxial cables. When the first and second conductors 3, 4 transmit electrical signals via the bio-nanowires 5″, the electrical signals respectively transmitted by the bio-nanowires 5″ are independent of each other and do not interfere with each other such that the bio-nanowire device 1 has an anisotropic conductive effect.

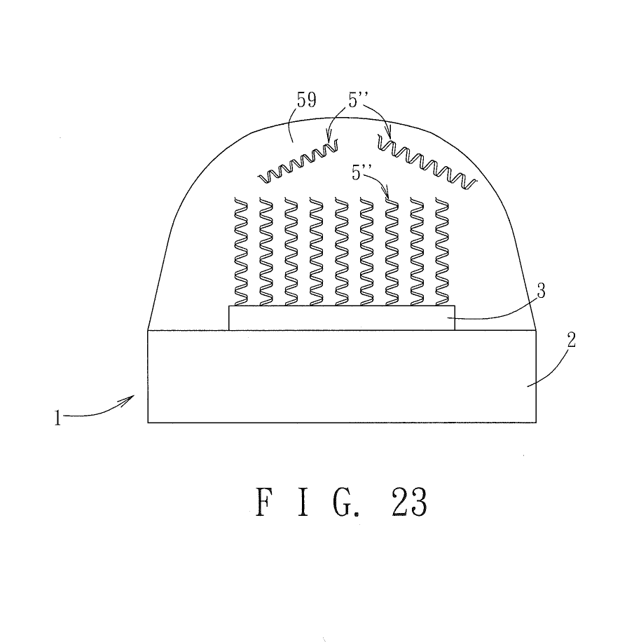

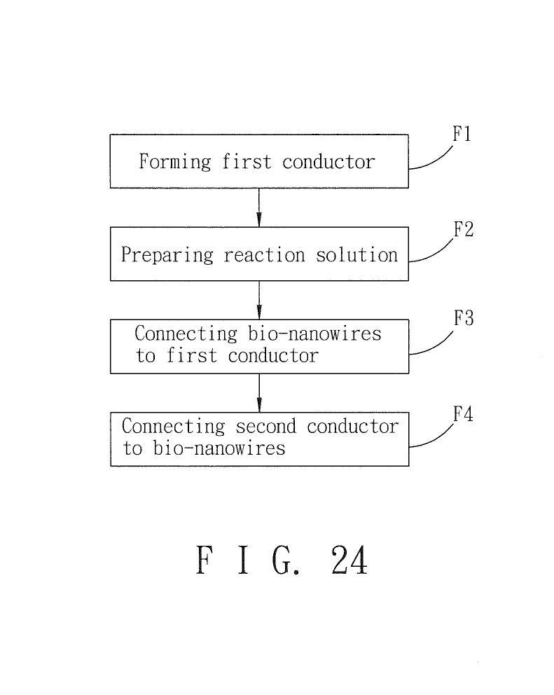

A method of fabricating the second preferred embodiment of the bio-nanowire device 1 will now be illustrated with reference to FIGS. 23 and 24.

### Step F1: Formation of First Conductor 3

The first conductor 3 is formed on the first surface 21 of the substrate 2 via semiconductor technology. The process of forming the first conductor 3 according to the second preferred embodiment is similar to that of forming the first conductor 3 according to the first preferred embodiment as described in step S1, and the detailed description thereof is omitted herein for the sake of brevity. Furthermore, the first conductor 3 may be subjected to surface grinding using alumina powder, and may be subjected to electrolytic polishing in a 0.5 M sulfuric acid solution, so as to improve surface smoothness.

### Step F2: Preparation of Reaction Solution 59

Reaction solution 59 containing the bio-nanowires 5″, each of which has the thiol group 58, is prepared in this step.

First, step S2 as described in the method of fabricating the first preferred embodiment of the bio-nanowire device 1 is conducted so as to prepare the above-mentioned reaction solution 54. Afterward, reaction solution 54 is subjected to thiolation using 6-mercapto-1-hexanol (HO(CH₂)₆SH) so that the 3′ end or the 5′ end of each of the bio-nanowires 5″ has the thiol group 58 transferred from 6-mercapto-1-hexanol. Consequently, preparation of reaction solution 59 is completed.

### Step F3: Connection of Bio-Nanowires 5″ to First Conductor 3 by Virtue of SAM Technique

This step is conducted so that the bio-nanowires 5″ in reaction solution 59 are vertically bonded to the surface of the first conductor 3 (made of a gold material, a silver material, or a copper material) via the thiol groups 58 thereof and therefore form a SAM (self-assembly monolayer) structure.

In detail, 2 μM reaction solution 59 is added dropwise to the first conductor 3, followed by being left standing still for 8 hours. The bio-nanowires 5″ in reaction solution 59 automatically bind to the surface of the first conductor 3 via the thiol groups 58 thereof, and are perpendicular to the surface of the first conductor 3. During this procedure, reaction solution 59 may be hermetically sealed with a cover so as to maintain the concentration and stability thereof. Thereafter, the first conductor 3 and the bio-nanowires 5″ connected thereto are soaked in a 0.1 M PBS (phosphate buffered saline) solution for 10 minutes, followed by washing with distilled water so as to remove the excess reaction solution 59 remaining on the first conductor 3.

### Step F4: Connection of Second Conductor 4 to Bio-Nanowires 5″

This step is conducted so that the second conductor 4 made of gold colloidal particles or micro- to sub-micro scale metal coated polystyrene beads is connected to the other end of each of the bio-nanowires 5″, which is opposite to the end connected to the first conductor 3. Accordingly, the fabrication of the bio-nanowire device 1 having anisotropic conductivity is completed.

Since the second conductor 4 is not disposed on the first surface 21 of the substrate 2, the first and second conductors 3, 4 according to the second preferred embodiment can be respectively deemed to be electrodes of two electronic components. Since the surface of the first conductor 3 is connected to one end of each of the bio-nanowires 5″ via the respective thiol group 58, and since the second conductor 4 is connected to the other end of each of the bio-nanowires 5″, these two electronic components can transmit electrical signals by virtue of the bio-nanowires 5″, such as co-axial cables, so as to achieve anisotropic conductivity.

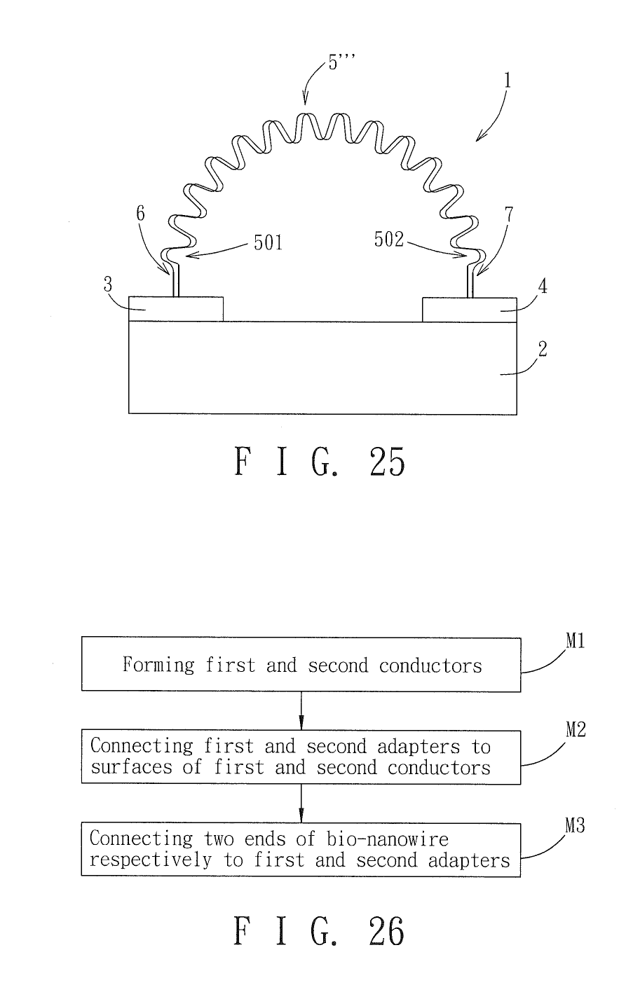

FIGS. 25 and 28 show the third preferred embodiment of the bio-nanowire device 1 according to the present invention. The third preferred embodiment and the first preferred embodiment are similar, except that: the third preferred embodiment of the bio-nanowire device 1 further includes a first linker 6 and a second linker 7. Each of the first and second linkers 6, 7 is substantially composed of nucleic acids, and has at least one metal ion (not shown) that is bonded between the nucleic acids via chelation. The first and second linkers 6, 7 are respectively connected to the first and second conductors 3, 4 by virtue of a SAM technique. The process of preparing the first and second linkers 6, 7 will be described in detail in the following paragraphs. In the third preferred embodiment, the two ends of the bio-nanowire 5′″ are connected to the first and second conductors 3, 4 respectively via the first and second linkers 6, 7. Accordingly, connection of the bio-nanowire 5′″ to the first and second conductors 3, 4 according to the third preferred embodiment differs from that of the first preferred embodiment.

In the third preferred embodiment, the first and second conductors 3, 4 are made of gold, silver, or copper. The structure of the bio-nanowire 5′″ according to the third preferred embodiment is similar to that of the bio-nanowire 5 according to the first preferred embodiment, and also contains a plurality of metal ions (not shown), each of which is bonded between the respective base pair via chelation. However, the nucleic acid molecules of the bio-nanowire 5′″ are respectively subjected to two different restriction enzyme treatments (e.g., treatments using Bam HI and EcoRI) so that a first sticky end 501 and a second sticky end 502 are formed at the two ends of the bio-nanowire 5′″.

The first linker 6 includes a first nucleic acid primer 61, a second nucleic acid primer 62, and at least one metal ion (not shown) bonded between the first and second nucleic acid primers 61, 62 via chelation. The lengths of the first and second nucleic acid primers 61,62 range from 20 to 30 nucleotides, and are different from each other. The shorter one of the first and second nucleic acid primers 61, 62 is complementary in nucleotide sequence to a portion of the longer one of the first and second nucleic acid primers 61, 62. Thus, the first and second nucleic acid primers 61, 62 form a sticky end that can be ligated to the first sticky end 501 of the bio-nanowire 5′″ by virtue of hybridization. At least one of the first and second nucleic acid primers 61, 62 has a thiol group at one end thereof, which is opposite to the other end to be ligated to the first sticky end 501 of the bio-nanowire 5′″, and is hence capable of forming a gold-sulfur bond, a silver-sulfur bond, or a copper-sulfur bond with the first conductor 3. Accordingly, the first sticky end 501 of the bio-nanowire 5′″ can be connected to the first conductor 3 via the first linker 6. It should be noted that: the first and second nucleic acid primers 61, 62 may be designed so that only one or each of the first and second nucleic acid primers 61, 62 has a thiol group.

Similarly, the second sticky end 502 of the bio-nanowire 5′″ is connected to the second conductor 4 by virtue of the second linker 7. The second linker 7 includes a third nucleic acid primer 71, a fourth nucleic acid primer 72, and at least one metal ion (not shown) bonded between the third and fourth nucleic acid primers 71, 72 via chelation. The lengths of the third and fourth nucleic acid primers 71, 72 are different from each other. The shorter one of the third and fourth nucleic acid primers 71, 72 is complementary in nucleotide sequence to a portion of the longer one of the third and fourth nucleic acid primers 71, 72. Thus, the third and fourth nucleic acid primers 71, 72 form a sticky end that can be ligated to the second sticky end 502 of the bio-nanowire 5′″ by virtue of hybridization. At least one of the third and fourth nucleic acid primers 71,72 has a thiol group at one end thereof, which is opposite to the other end to be ligated to the second sticky end 502 of the bio-nanowire 5′″, and is hence capable of forming a gold-sulfur bond, a silver-sulfur bond, or a copper-sulfur bond with the second conductor 4.

In this embodiment, the first and second sticky ends 501, 502 of the bio-nanowire 5′″ are connected to the first and second conductors 3, 4 respectively via the first and second linkers 6, 7, and thus the third preferred embodiment of the bio-nanowire device 1 can also be used to perform different functions so as to serve as a diode, a memristor, a spintronic device, or a biosensor. It should be noted that: the two ends of the bio-nanowire 5′″ may be directly connected to the first and second conductors 3,4 via electrostatic force; and the connection of the two ends of the bio-nanowire 5′″ to the first and second conductors 3,4 can be flexibly adjusted as required, and therefore is not limited to the above description.

A method of fabricating the third preferred embodiment of the bio-nanowire device 1 will now be illustrated with reference to FIGS. 26 to 28.

### Step M1: Formation of First and Second Conductors 3, 4

In this step, the first and second conductors 3, 4 are formed on the substrate 2 using electrically conductive materials. The formation of the first and second conductors 3, 4 according to the third preferred embodiment is the same as that according to the first preferred embodiment (see step S1), and hence will not be described further for the sake of brevity.

### Step M2: Connection of First and Second Linkers 6, 7 to Surfaces of First and Second Conductors 3, 4 by Virtue of SAM Technique

In this step, the first and second linkers 6, 7 are connected to the surfaces of the first and second conductors 3, 4 via a SAM technique. Nucleotide sequences of DNA fragments belonging to each of the first and second linkers 6, 7 are shown in Table 1 below. The first sense fragment corresponds to the first nucleic acid primer 61, and the first antisense fragment corresponds to the second nucleic acid primer 62. The second sense fragment corresponds to the fourth nucleic acid primer 72, and the second antisense fragment corresponds to the third nucleic acid primer 71. In this embodiment, each of the first and third nucleic acid primers 61, 71 has a thiol group at 5′ end thereof.

TABLE 1
Nucleotide sequences
of DNA fragments of each linker

| | | Nucleotide sequence |
|---|---|---|
| Linker | DNA fragment | (5′→3′) |
| First | First sense | gttctgacccacaacg |
| linker | fragment | (SEQ ID NO: 1) |
| | First antisense | aattcgttgtgggtcagaac |
| | fragment | (SEQ ID NO: 2) |
| Second | Second sense | caccgcagctttcatg |
| linker | fragment | (SEQ ID NO: 3) |
| | Second antisense | gatccatgaaagctgcggtg |
| | fragment | (SEQ ID NO: 4) |

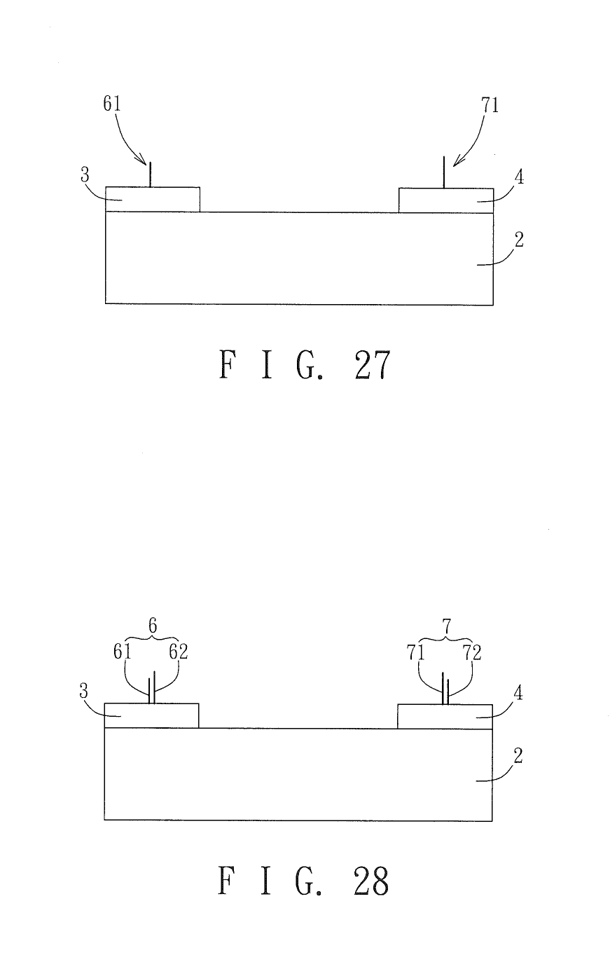

Referring to FIG. 27, 1 μM (1 μmol/L) aqueous solutions respectively containing the first and third nucleic acid primers 61, 71 were mixed together, and 5 μL of the resultant mixture solution was added dropwise to the first and second conductors 3, 4, followed by being left standing still for 6 hours to 12 hours. Thus, each of the first and third nucleic acid primers 61, 71 formed a gold-sulfur bond (or a silver-sulfur bond or a copper-sulfur bond in other embodiments) with a respective one of the first or second conductors 3, 4 via the thiol group such that a self-assembly monolayer (SAM) is formed. As shown in FIG. 27, the surfaces of the first conductor 3 and second conductor 4 are connected to first nucleic acid primer 61 SAM and/or third nucleic acid primers 71 SAM. It should be noted that the total amount of the first nucleic acid primer 61 and the third nucleic acid primer 71 connected to the first conductor 3 and second conductor 4 are not limited to the aforesaid. To be more precise, the total amount of the first nucleic acid primer 61 and the total amount of the third nucleic acid primer 71 may be more than one, i.e., the surfaces of the first and second conductors 3, 4 may be respectively connected to a plurality of the first nucleic acid primers 61 and a plurality of the third nucleic acid primers 71.

Referring to FIG. 28, 2 μL of a 1 μM (1 μmol/L) solution (pH 9.0) containing the second nucleic acid primer 62 complementary to the first nucleic acid primer 61, the fourth nucleic acid primer 72 complementary to the third nucleic acid primer 71, and double-distilled water (ddH₂O), and 2 μL of a nickel-containing solution (the nickel ion concentration thereof is 100 μM) were added dropwise to the first and second conductors 3,4, followed by being left standing still for 12 hours. Consequently, the second and fourth primers 62, 72 were respectively formed into base pairs with the first and third primers 61, 71. Thus, the first and second linkers 6, 7 having the metal ions (not shown) bonded therein via chelation were prepared.

The first and second conductors 3, 4 were rinsed with double-distilled water (pH 9.0) thrice so as to remove excess salts and nickel ions.

It should be noted that the surfaces of the first and second conductors 3, 4 may be respectively connected to a plurality of the first linkers 6 and a plurality of the second linkers 7 via a SAM technique so that a plurality of the bio-nanowires 5′″ instead of one can be connected between the first and second conductors 3,4. Preferably, the concentration of each of the first, second, third, and fourth nucleic acid primers 61, 62, 71, 72 in the aqueous solution ranges from 0.01 to 10 μmol/L; the concentration of the metal ions in the metal-containing solution ranges from 10 μmol/L to 10 mmol/L; and the aqueous solution containing the second and fourth nucleic acid primers 62 and 72 and the nickel-containing solution are in a volume ratio ranging from 0.1 to 10.

### Step M3: Connection of Two Ends of Bio-Nanowire Respectively to First and Second Linkers 6, 7

This step is conducted so that the bio-nanowire 5′″ is connected to the first and second conductors 3, 4 by virtue of the first and second linkers 6, 7.

First, genomic DNA was extracted from Chinese hamster ovary (CHO) cells (BCRC 60006) using Genomic DNA Purification Kit (GeneMark, Cat. No. DP02-150). The CHO cells can be purchased from Biosource Collection and Research Center (BCRC) of Food Industry Research and Development Institute (FIRDI) (331 Shih-Pin Road, Hsinchu 300, Taiwan).

Subsequently, the genomic DNA thus obtained served as a template, and a primer pair designed based on the nucleotide sequence of NCBI Accession No. NM_{—}001243976 (mRNA of Cricetulus griseus p53 tumor suppressor (P53)) and having the nucleotide sequences shown below was used, so as to conduct a polymerase chain reaction (PCR) under the reaction conditions shown in Table 2 below. Therefore, the amplified PCR products (1,193 bps) containing a Cricetulus griseus p53 gene were obtained.

TABLE 2
PCR reaction conditions

| Contents | Volume (μL) |
|---|---|
| Genomic DNA of CHO cells (0.01 μg/μL) | 2 |
| p53 forward primer (2.5 μM) | 1 |
| p53 reverse primer (2.5 μM) | 1 |
| dNTPs (10 mM) | 1 |
| Taq DNA polymerase | 0.2 |
| Taq DNA polymerase buffer (10X) | 2.5 |
| MgC1₂ (25 mM) | 5 |
| ddH₂O | 12.3 |

Operating conditions: Denaturation at 95° C. for 5 minutes, followed by 37 cycles of the following reactions: denaturation at 95° C. for 30 seconds, primer annealing at 60° C. for 30 seconds, and elongation at 72° C. for 2 minutes; and finally extension at 72° C. for 4 minutes.
p53 forward primer:
5′-caccatggaggagccacagt-3′ (SEQ ID NO: 5)
p53 reverse primer:
5′-aaggaagtcagtccgagtca-3′ (SEQ ID NO: 6)

After the polymerase chain reaction was completed, the PCR products thus obtained were subjected to 1% agarose gel electrophoresis so as to verify the molecular weight thereof, followed by recovery and purification using QIAquick PCR Purification Kit (QIAGEN, Cat. No. 28106). Afterward, the purified PCR products were incorporated into pET200/D-TOPO® plasmids (5,741 bps) using Champion™ pET200 Directional TOPO® Expression Kit (Life Technologies, USA, Cat. No. K200-01) according to the manufacturer's instructions such that recombinant plasmids pET200-p53 (6,930 bps) were obtained.

Open reading frame of the recombinant plasmids pET200-p53 was confirmed via nucleotide sequencing. After the confirmation, the recombinant plasmids pET200-p53 served as a template, and a primer pair designed based on the recombinant plasmids pET200-p53 and having the nucleotide sequences shown below was used, so as to conduct a polymerase chain reaction under the reaction conditions shown in Table 2 above. Thus, the PCR products (1,871 bps) containing an EcoRI/BamHI restriction site were obtained.

| | |
|---|---|
| pET200-p53 forward primer: | |
| 5'-gaattctacgactcactata-3' | (SEQ ID NO: 7) |
| EcoRI | |
| pET200-p53 reverse primer: | |
| 5'-ggatccatttagaaaaataa-3' | (SEQ ID NO: 8) |
| BamHI | |

The aforesaid two primers are respectively designed to have restriction sites (underlined) for restriction enzymes EcoRI and BamHI.

After the polymerase chain reaction was completed, the PCR products thus obtained were subjected to 1% agarose gel electrophoresis so as to verify the molecular weight thereof, followed by recovery and purification using QIAquick PCR Purification Kit. The purified PCR products were used to prepare reaction solution 54 containing the bio-nanowires 5 according to the method as described in step S2 above. Subsequently, the bio-nanowires 5 were subjected to cleavage using restriction enzymes EcoRI and BamHI so that reaction solution 54′ (not shown) containing the bio-nanowires 5′″ (1,869 bps, SEQ ID NO: 9) was prepared. Each of the bio-nanowires 5′″ thus formed has the first sticky end 501 and the second sticky end 502.

5 μL of 200 nM (nmol/L) reaction solution 54′ was added dropwise to the first and second conductors 3, 4 formed in step M2 above, followed by being left standing still for 20 minutes. Therefore, the first and second sticky ends 501, 502 of the bio-nanowire 5′″ are connected respectively to the first and second linkers 6, 7. During this procedure, reaction solution 54′ may be hermetically sealed with a cover so as to maintain the concentration thereof. The excess reaction solution 54′ remaining on the first and second conductors 3, 4 was slowly blown off using nitrogen gas, thereby completing the fabrication of the bio-nanowire device 1.

It should be noted that the concentration of reaction solution 54′ and the time required for connecting the bio-nanowire 5′″ to the first and second conductors 3, 4 can be adjusted as desired, and are not limited to the above description.

Since the bio-nanowire 5′″ according to the third preferred embodiment is connected to the first and second conductors 3, 4 via the first and second linkers 6, 7, the bio-nanowire 5′″ is different from the bio-nanowire 5 according to the first preferred embodiment (which is connected to the first and second conductors 3,4 via electrostatic force) and is different from the bio-nanowire 5″ according to the second preferred embodiment (which is connected to the first conductor 3 directly via the thiol group) in terms of the connection method. Nevertheless, the aforesaid three bio-nanowires 5, 5″, 5′″ are able to perform the same function. Even though the bio-nanowire device 1 shown in FIG. 25 includes only one bio-nanowire 5′″, the total amount of the bio-nanowire 5′″ may be more than one.

In view of the foregoing, the bio-nanowire device 1 of this invention is capable of performing different functions so as to serve as a diode, a memristor, a spintronic device, or a biosensor, under suitable operating conditions.

While the present invention has been described in connection with what are considered the most practical and preferred embodiments, it is understood that this invention is not limited to the disclosed embodiments but is intended to cover various arrangements included within the spirit and scope of the broadest interpretation and equivalent arrangements.

What is claimed is:

1. A bio-nanowire device, comprising:
a substrate having a first surface;
a first conductor disposed on said first surface of said substrate;
a second conductor disposed on said first surface of said substrate and spaced apart from said first conductor; and
a bio-nanowire that has two ends respectively connected to said first and second conductors and that includes a nucleic acid molecule having two nucleotide segments, and a plurality of metal ions bonded between said two nucleotide segments of said nucleic acid molecule, said two nucleotide segments forms a double helix structure via base pairs,
wherein when a voltage or a current is applied to said bio-nanowire, the oxidation state of said metal ions can be changed such that the non-linear electroconductive characteristic of said bio-nanowire can be controlled.

2. The bio-nanowire device of claim 1, wherein said two nucleotide segments of said nucleic acid molecule respectively form first and second nucleotide strands that are helically intertwined to form the double helix structure, nucleotides of said first nucleotide strand completely match nucleotides of said second nucleotide strand and bond to said nucleotides of said second nucleotide strand via hydrogen bonding and chelation of said metal ions.

3. The bio-nanowire device of claim 1, wherein said two nucleotide segments of said nucleic acid molecule respectively form first and second nucleotide strands that are helically intertwined to form the double helix structure, at least one of nucleotides of said first nucleotide strand mismatches a respective at least one of nucleotides of said second nucleotide strand, others of said nucleotides of said first nucleotide strand match others of said nucleotides of said second nucleotide strands and bond to said nucleotides of said second nucleotide strand via hydrogen bond and chelation of said metal ions.

4. The bio-nanowire device of claim 1, wherein said nucleic acid molecule is composed of a single-stranded structure having said two nucleotide segments and is bent such that said two nucleotide segments match each other and form the double helix structure.

5. The bio-nanowire device of claim 1, wherein each of said nucleotide segments is composed of ribonucleotides or deoxyribonucleotides

6. The bio-nanowire device of claim 5, wherein each of said nucleotide segments is composed of deoxyribonucleotides selected from the group consisting of adenine nucleotides, guanine nucleotides, thymine nucleotides, cytosine nucleotides, and combinations thereof.

7. The bio-nanowire device of claim 1, wherein said metal ions are selected from the group consisting of nickel ions, copper ions, zinc ions, cobalt ions, iron ions and combinations thereof.

8. The bio-nanowire device of claim 1, further comprising first and second linkers, each of said first and second linkers being composed of nucleic acids and at least one metal ion that is bonded between said nucleic acids, said two ends of said bio-nanowire being respectively connected to said first and second conductors via said first and second linkers.

9. The bio-nanowire device of claim 8, wherein said bio-nanowire has first and second sticky ends at said two ends thereof, said first and second conductors being respectively made of gold, silver or copper, said first linker including a first nucleic acid primer, a second nucleic acid primer matching said first nucleic acid primer in nucleotide sequence, and at least one metal ion bonded between said first and second nucleic acid primers, said first and second nucleic acid primers having different lengths and forming a sticky end that is ligated to said first sticky end of said bio-nanowire, each of said first and second nucleic acid primers of said first linker having a thiol group so as to form a gold-sulfur bond, a silver-sulfur or a copper-sulfur bond with said first conductor, said second linker including a third nucleic acid primer, a fourth nucleic acid primer matching said third nucleic acid primer in nucleotide sequence, and at least one metal ion bonded between said third and fourth nucleic acid primers, said third and fourth nucleic acid primers having different lengths and forming a sticky end that is ligated to said second sticky end of said bio-nanowire, each of said third and fourth nucleic acid primers of said second linker having a thiol group so as to form a gold-sulfur bond, a silver-sulfur bond or copper-sulfur bond with said second conductor.

10. The bio-nanowire device of claim 1, wherein said metal ions have a relatively lower oxidation state under a negative setting voltage and have a relatively higher oxidation state under a positive setting voltage, so that the non-linear electroconductive characteristic of said bio-nanowire can be controlled through the oxidation state of said metal ions.

11. The bio-nanowire device of claim 1, wherein said first and second conductors are spaced apart from each other by a distance ranging from 5 nanometers to 1 micrometer.

12. The bio-nanowire device of claim 11, wherein said first and second conductors are spaced apart from each other by a distance ranging from 20 nm to 300 nm.

13. The bio-nanowire device of claim 1, wherein each of said first and second conductors is made from a material selected from the group consisting of metal, graphite, metal oxides, and conductive polymeric materials.

14. The bio-nanowire device of claim 1, wherein said bio-nanowire device is used as a spintronic device, and each of said first and second conductors is made from a magnetic metal.

15. The bio-nanowire device of claim 14, wherein said magnetic metal is iron, cobalt, or nickel.

16. The bio-nanowire device of claim 1, further comprising a fluidic channel adapted to allow a sample solution to flow therethrough to said bio-nanowire.

17. The bio-nanowire device of claim 1, wherein said two ends of said bio-nanowire are connected to said first and second conductors via electrostatic force.

18. A bio-nanowire device, comprising:
a substrate having a first surface;
a first conductor disposed on said first surface of said substrate;
a second conductor disposed apart from said substrate and said first conductor; and
a plurality of electrically isolated bio-nanowires each of which has two ends respectively connected to said first and second conductors and each of which includes a nucleic acid molecule having two nucleotide segments, and a plurality of metal ions bonded to said two nucleotide segments so as to form an electron transport path, said two nucleotide segments form a double helix structure via base pairs,
wherein when a voltage or a current is applied to said bio-nanowires, the oxidation state of said metal ions can be changed such that the non-linear electroconductive characteristic of said bio-nanowires can be controlled.

19. The bio-nanowire device of claim 18, wherein said two nucleotide segments of said nucleic acid molecule of each of said bio-nanowires respectively form first and second nucleotide strands that are helically intertwined to form the double helix structure, nucleotides of said first nucleotide strand completely match nucleotides of said second nucleotide strand and bond to said nucleotides of said second nucleotide strand via hydrogen bonding and chelation of said metal ions.

20. The bio-nanowire device of claim 18, wherein said two nucleotide segments of said nucleic acid molecule of each of said bio-nanowires respectively form first and second nucleotide strands that are helically intertwined to form the double helix structure, at least one of nucleotides of said first nucleotide strand mismatches a respective at least one of nucleotides of said second nucleotide strand, others of said nucleotides of said first nucleotide strand match others of said nucleotides of said second nucleotide strands and bond to said nucleotides of said second nucleotide strand via hydrogen bond and chelation of said metal ions.

21. The bio-nanowire device of claim 18, wherein said nucleic acid molecule of each of said bio-nanowires is composed of a single-stranded structure having said two nucleotide segments and is bent such that said two nucleotide segments match each other and form the double helix structure.

22. The bio-nanowire device of claim 18, wherein each of said nucleotide segments is composed of ribonucleotides or deoxyribonucleotides.

23. The bio-nanowire device of claim 18, wherein each of said nucleotide segments is composed of deoxyribonucleotides selected from the group consisting of adenine nucleotides, guanine nucleotides, thymine nucleotides, cytosine nucleotides, and combinations thereof.

24. The bio-nanowire device of claim 18, wherein said metal ions are selected from the group consisting of nickel ions, copper ions, zinc ions, cobalt ions, iron ions and combinations thereof.

25. The bio-nanowire device of claim 18, wherein said first conductor is made of gold, silver or copper, at least one of said two nucleotide segment of each of said bio-nanowires has a thiol group, each of said bio-nanowires being connected to said first conductor via a gold-sulfur bond, a silver-sulfur bond, or a copper-sulfur bond.

26. The bio-nanowire device of claim 18, which is an anisotropic conductive structure.

27. A method of fabricating a bio-nanowire device, comprising the steps of:
(a) forming separated first and second conductors on a surface of a substrate;
(b) providing first and second linkers each of which is composed of nucleic acids and at least one metal ion that is bonded between the nucleic acids, and connecting the first and second linkers to the first and second conductors, respectively,
(c) connecting a bio-nanowire to the first and second linkers such that the bio-nanowire interconnects the first and second conductors, the bio-nanowire including a nucleic acid molecule, and a plurality of metal ions bonded to the nucleic acid molecule.

28. The method of claim 27, wherein, in step (a), the first and second conductors is made of gold, silver, or copper, and, in step (b), each of the first and second linkers has a thiol group, the first and second linkers being respectively connected to the first and second conductors by virtue of gold-sulfur bond, silver-sulfur bond, or copper-sulfur bond.

29. The method of claim 28, wherein, in step (c), the bio-nanowire has first and second sticky ends that are formed by subjecting the nucleic acid molecule to two different restriction enzyme treatments and that are respectively connected to the first and second linkers.

30. The method of claim 29, wherein, in step (b), the first linker includes a first nucleic acid primer, a second nucleic acid primer matching the first nucleic acid primer in nucleotide sequence, and at least one metal ion bonded between the first and second nucleic acid primers, the first and second nucleic acid primers having different lengths and forming a sticky end that is ligated to the first sticky end of the bio-nanowire, at least one of the first and second nucleic acid primers of the first linker having the thiol group so as to form the gold-sulfur bond, the silver-sulfur bond or copper-sulfur bond with the first conductor, the second linker including a third nucleic acid primer, a fourth nucleic acid primer matching the third nucleic acid primer in nucleotide sequence, and at least one metal ion bonded between the third and fourth nucleic acid primers, the third and fourth nucleic acid primers having different lengths and forming a sticky end that is ligated to the second sticky end of the bio-nanowire, at least one of the third and fourth nucleic acid primers of the second linker having the thiol group so as to form the gold-sulfur bond, the silver-sulfur bond or the copper-sulfur bond with the second conductor.

31. The method of claim 30, wherein step (b) further includes the following substeps:
(b1) adding dropwise a solution containing the first and third nucleic acid primers onto the first and second conductors and allowing each of the first and third nucleic acid primers to form the gold-sulfur bond, the silver-sulfur bond or the copper-sulfur bond with a respective one of the first and second conductors;
(b2) adding dropwise a solution containing the second nucleic acid primer complementary to the first nucleic acid primer, and fourth nucleic acid primer complementary to the third nucleic acid primer and a metal-containing solution containing metal ions onto the first and second conductors and allowing the second and fourth nucleic acid primers to be respectively bonded to the first and second conductors and allowing the metal ions to be chelated between the first and second nucleic acid primers and between the third and fourth nucleic acid primers.

32. The method of claim 31, wherein
in step (b1), the concentration of each of the first and third nucleic acid primers in the solution ranges from 0.01 μmol/L to 10 μmol/L and the solution is left standing on the first and second conductors for 6 hours to 12 hours; and
in step (b2), the concentration of each of the second and fourth nucleic acid primers in the solution ranges from 0.01 μmol/L to 10 μmol/L, the concentration of the metal ions in the metal-containing solution ranges from 10 μmol/L to 10 mmol/L, and the solution containing the second and
